(19) United States
(12) Patent Application Publication
(10) Pub. No.: US 2026/0146656 A1
(43) Pub. Date: May 28, 2026

(54) BRAKING DEVICE

(71) Applicant: Luxshare Intelligent Manufacture Technology (Changshu) Co.,Ltd, Changshu City (CN)

(72) Inventors: Zihshuo Huang, Changshu City (CN); Poying Tseng, Changshu City (CN); Fuyuan WU, Changshu City (CN)

(73) Assignee: Luxshare Intelligent Manufacture Technology (Changshu) Co.,Ltd, Changshu City (CN)

(21) Appl. No.: 19/022,627

(22) Filed: Jan. 15, 2025

(30) Foreign Application Priority Data
Nov. 28, 2024 (CN) 202411729992.1

(51) Int. Cl. F16D 63/00; F03G 7/06; F16D 66/00; F16D 121/34

(52) U.S. Cl. CPC F16D 63/00; F03G 7/06143; F03G 7/066; F16D 2066/003; F16D 2121/34

(57) ABSTRACT

Provided is a braking device. The braking device includes a support base, a swing arm, a brake elastic member, a brake member, a first shape memory alloy wire, and a second shape memory alloy wire. The swing arm is mounted on the support base and configured to swing relative to the support base. The brake elastic member is connected to the support base. The brake member is connected to the support base by the brake elastic member and configured to be driven by the brake elastic member to abut and lock the swing arm. The first shape memory alloy wire is disposed on the support base and configured to drive the swing arm to swing when energized. The second shape memory alloy wire is disposed on the support base and configured to drive the brake member away to release the swing arm when energized.

### CROSS-REFERENCE TO RELATED APPLICATION(S)

This application claims priority of a Chinese Patent Application filed with China National Intellectual Property Administration (CNIPA) on Nov. 28, 2024, with application No. 202411729992.1, the disclosure of which is incorporated herein by reference in their entirety.

### TECHNICAL FIELD

The present disclosure relates to the technical field of braking devices, particularly a braking device.

### BACKGROUND

Shape memory alloys (SMAs) are a kind of alloys that return to their original shape before deformation when being heated. Shape memory alloy wires are wires made of the shape memory alloys. During use, an electric current is applied to a shape memory alloy wire to generate Joule heat to cause the wire to deform. Compared with traditional electromechanical, hydraulic, pneumatic, and other braking devices, braking devices using shape memory alloy wires have advantages such as simple structure, high energy density, low noise, and stable reliability, making them widely applied to fields such as bionic robots, micro-electromechanical systems, and aerospace. In an existing braking device, a swing arm is driven by a shape memory alloy wire to produce a brake stroke. However, to maintain the brake stroke, the shape memory alloy wire is required to remain energized, resulting in high energy consumption.

To address this problem, the related art uses a swingable brake arm to abut and lock a swing arm, thus achieving the maintenance of a brake stroke. However, to ensure the locking effect when the rotation is in place, the existing brake arm occupies a large space during assembly and has high tolerance requirements, increasing the manufacturing costs.

### SUMMARY

An object of the present disclosure is to provide a braking device to effectively reduce the occupied space of a brake structure, lower the tolerance requirements, and compress the manufacturing costs.

To achieve this object, the present disclosure uses the following solutions:

A braking device includes a support base, a swing arm, a brake elastic member, a brake member, a first shape memory alloy wire, and a second shape memory alloy wire. The swing arm is mounted on the support base and configured to swing relative to the support base. The brake elastic member is connected to the support base. The brake member is connected to the support base through the brake elastic member and configured to be driven by the brake elastic member to abut and lock the swing arm. The first shape memory alloy wire is disposed on the support base and configured to drive the swing arm to swing when energized. The second shape memory alloy wire is disposed on the support base and configured to drive the brake member away from the swing arm to release the swing arm when energized.

In one or more embodiments, the brake elastic member includes a first fixed support arm, a first intermediate part, and a first movable support arm connected in sequence. The first fixed support arm is connected to the support base. The first movable support arm is connected to the brake member.

In one or more embodiments, the braking device also includes a swing arm elastic member that connects the swing arm to the support base.

In one or more embodiments, the swing arm elastic member includes a second fixed support arm, a second intermediate part, and a second movable support arm connected in sequence. The second fixed support arm is connected to the support base. The second movable support arm is connected to the swing arm.

In one or more embodiments, the swing arm is rotatably connected to the support base.

In one or more embodiments, two first shape memory alloy wires are provided, and the two first shape memory alloy wires are configured to drive the swing arm to swing in opposite directions.

In one or more embodiments, the swing arm is provided with a traction part, an actuator part, and a stopper part. The first shape memory alloy wire is configured to drive the traction part to move. The brake member is configured to abut the stopper part.

In one or more embodiments, the stopper part has a curved surface, and the brake member is configured to abut different positions of the curved surface when the actuator part moves to different positions.

In one or more embodiments, the brake member is provided with a force-receiving part, and the second shape memory alloy wire is configured to drive the force-receiving part to move.

In one or more embodiments, the braking device also includes a sensor disposed on the support base and configured to detect the position of the actuator part of the swing arm.

The present disclosure has the following beneficial effects:

The brake member is connected to the support base by the brake elastic member. On the support base, the brake member is fully supported by the brake elastic member. The brake member can be driven by the brake elastic member itself to abut and lock the swing arm, allowing the swing arm to achieve zero holding energy and efficiently maintain the brake stroke, ensuring the locking effect. The second shape memory alloy wire can drive the brake member to pull the brake elastic member to elastically deform, causing the brake member to move away from the swing arm. When the brake member moves away from the swing arm, the locking of the swing arm is released. This arrangement omits components and structures for rotational connection, such as shafts and bearings, and thus reduces the tolerance requirements. This allows the brake member to occupy an effectively reduced space compared with an existing brake arm, and incur lower manufacturing costs on the premise of ensuring the locking effect.

### BRIEF DESCRIPTION OF DRAWINGS

FIG. 1 is a structure view of a braking device according to embodiment one of the present disclosure.

FIG. 2 is a rear view of a braking device according to embodiment one of the present disclosure.

FIG. 3 is a structure view of a braking device without swing arm and brake member according to embodiment one of the present disclosure.

FIG. 4 is a structure view of a swing arm according to embodiment one of the present disclosure.

FIG. 5 is a structure view of a brake member according to embodiment one of the present disclosure.

FIG. 6 is a structure view of a braking device according to embodiment two of the present disclosure.

FIG. 7 is a rear view of a braking device according to embodiment two of the present disclosure.

FIG. 8 is a structure view of a braking device according to embodiment two of the present disclosure.

FIG. 9 is a rear view of a braking device according to embodiment two of the present disclosure.

Reference list

| | |
|---|---|
| 1 | support base |
| 11 | bottom support plate |
| 12 | separator plate |
| 2 | swing arm |
| 21 | traction part |
| 22 | actuator part |
| 23 | stopper part |
| 3 | brake elastic member |
| 31 | first fixed support arm |
| 32 | first intermediate part |
| 33 | first movable support arm |
| 4 | brake member |
| 41 | force-receiving part |
| 5 | first shape memory alloy wire |
| 6 | second shape memory alloy wire |
| 7 | swing arm elastic member |
| 71 | second fixed support arm |
| 72 | second intermediate part |
| 73 | second movable support arm |

### DETAILED DESCRIPTION

Embodiments of the present disclosure are described in detail below. Examples of the embodiments are illustrated in the drawings, where the same or similar reference numerals throughout the drawings represent the same or similar components or components having the same or similar functions. The embodiments described below with reference to the drawings are illustrative and intended to explain the present disclosure and cannot be construed as limiting the present disclosure.

In the description of the present disclosure, terms “joined”, “connected”, and “fixed” are to be understood in a broad sense unless otherwise expressly specified and limited. For example, the term “connected” may refer to “fixedly connected” or “detachably connected”, may refer to “mechanically connected” or “electrically connected”, may refer to “connected directly” or “connected indirectly through an intermediary”, or may refer to “connected inside two elements” or “an interaction relation between two elements”. For those of ordinary skill in the art, specific meanings of the preceding terms in the present disclosure may be understood based on specific situations.

In the description of the present disclosure, unless otherwise expressly specified and limited, when a first feature is described as “above” or “below” a second feature, the first feature and the second feature may be in direct contact, or the first feature and the second feature may be in contact via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

Technical solutions in the present disclosure are further described below in conjunction with the drawings and embodiments.

### EMBODIMENT ONE

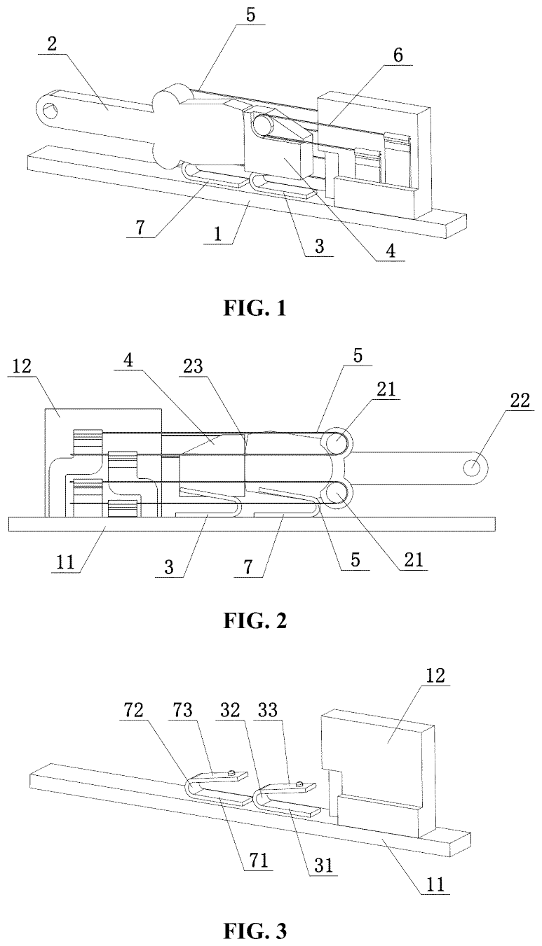

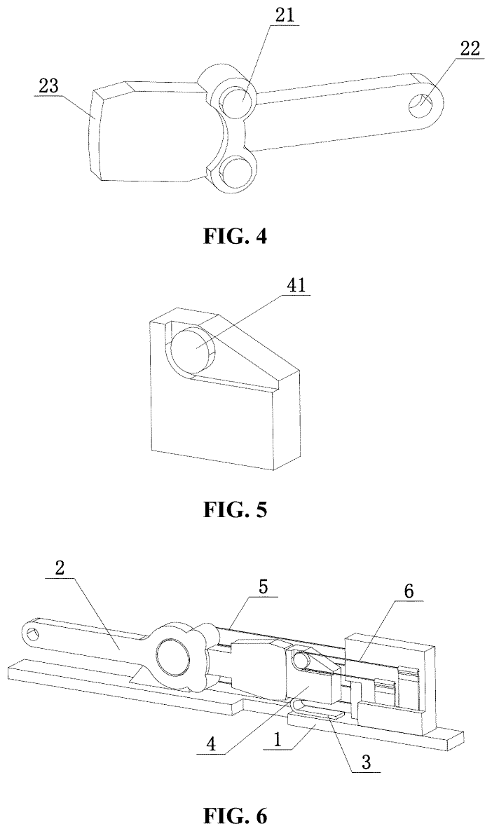

As shown in FIGS. 1 to 5, this embodiment provides a braking device. The braking device includes a support base 1, a swing arm 2, a brake elastic member 3, a brake member 4, a first shape memory alloy wire 5, and a second shape memory alloy wire 6. The swing arm 2 is mounted on the support base 1 and configured to swing relative to the support base 1. The brake elastic member 3 is connected to the support base 1. The brake member 4 is connected to the support base 1 by the brake elastic member 3. The brake elastic member 3 is configured to drive the brake member 4 to abut and lock the swing arm 2. The first shape memory alloy wire 5 is disposed on the support base 1 and configured to drive the swing arm 2 to swing when energized. The second shape memory alloy wire 6 is disposed on the support base 1 and configured to drive the brake member 4 away from the swing arm 2 to release the swing arm 2 when energized.

The brake member 4 is connected to the support base 1 by the brake elastic member 3. On the support base 1, the brake member 4 is fully supported by the brake elastic member 3. The brake member 4 can be driven by the brake elastic member 3 to abut and lock the swing arm 2, allowing the swing arm 2 to achieve zero holding energy and efficiently maintain the brake stroke, ensuring the locking effect. The second shape memory alloy wire 6 can drive the brake member 4 to pull the brake elastic member 3 to elastically deform, causing the brake member 4 to move away from the swing arm 2. When moving away from the swing arm 2, the brake member 4 releases the locking of the swing arm 2. This arrangement omits components and structures for rotational connection, such as shafts and bearings, and thus reduces the tolerance requirements. This allows the brake member 4 to have a guaranteed locking effect, occupy an effectively reduced space compared with an existing brake arm, and incur lower manufacturing costs.

In one or more embodiments, the support base 1 includes a bottom support plate 11 and a separator plate 12. The brake elastic member 3 is mounted on the bottom support plate 11. The separator plate 12 is vertically connected to the bottom support plate 11. The wire clip of the first shape memory alloy wire 5 and the wire clip of the second shape memory alloy wire 6 are located on two sides of the separator plate 12 respectively. This arrangement makes the first shape memory alloy wire 5 and the second shape memory alloy wire 6 safer when energized.

In this embodiment, the bottom support plate 11 is strip-shaped, and the layout direction of the separator plate 12 is parallel to the length direction of the bottom support plate 11. The wire clip of the first shape memory alloy wire 5 is secured to the bottom support plate 11. The wire clip of the second shape memory alloy wire 6 is secured to the separator plate 12.

In one or more embodiments, the swing arm 2 is provided with a traction part 21, an actuator part 22, and a stopper part 23. The first shape memory alloy wire 5 is configured to drive the traction part 21 to move. The brake member 4 is configured to abut the stopper part 23. This arrangement ensures smoother interaction between the swing arm 2, the first shape memory alloy wire 5, and the brake member 4, making the operation safer and more reliable.

In one or more embodiments, the stopper part 23 has a curved surface. When the actuator part 22 moves to different positions, the brake member 4 abuts different positions of the curved surface. This arrangement prevents poor abutment of the brake member 4 due to the deflection of the swing arm 2, ensuring the locking effect of the brake member 4.

In this embodiment, the actuator part 22 and the stopper part 23 are located at two ends of the swing arm 2, and the traction part 21 is located between the actuator part 22 and the stopper part 23. The swinging axis of the swing arm 2 relative to the support base 1 is a support axis. The distance from the traction part 21 to the support axis is smaller than the distance from the actuator part 22 to the support axis so that when the first shape memory alloy wire 5 drives the swing arm 2, the brake stroke is effectively increased while the driving force value and response speed are ensured.

In one or more embodiments, the traction part 21 has a protruding structure, and the first shape memory alloy wire 5 is wound around the traction part 21. This arrangement facilitates the application of force by the first shape memory alloy wire 5 to the traction part 21.

In one or more embodiments, the protruding structure of the traction part 21 is provided with a winding groove, and the first shape memory alloy wire 5 is inserted into the winding groove, thereby preventing the first shape memory alloy wire 5 from coming out of the traction part 21.

In this embodiment, one end of the swing arm 2 is provided with a straight rod, and the other end of the swing arm 2 is provided with a block. The cross-sectional area of the straight rod is smaller than that of the block. The actuator part 22 is a through hole disposed on the straight rod, facilitating the connection and assembly of other components, allowing for more flexible movement. The stopper part 23 is disposed on the end face of the block, with a larger area, making it more reliable when subjected to braking force. The traction part 21 is a circular or square protruding column, with its axis parallel to the extension direction of the first shape memory alloy wire 5. Two wire clips that cooperate with the first shape memory alloy wire 5 are disposed on the support base 1. The two ends of the first shape memory alloy wire 5 are connected to the two wire clips one to one. After the first shape memory alloy wire 5 is wound around the traction part 21, the two segments of the first shape memory alloy wire 5 are parallel to each other.

In other embodiments, the traction part 21 may also be a through passage disposed on the swing arm 2, making the assembly more secure, and ensuring that the first shape memory alloy wire 5 threaded through the traction part 21 is not easily detached from the swing arm 2.

In one or more embodiments, the brake elastic member 3 includes a first fixed support arm 31, a first intermediate part 32, and a first movable support arm 33 connected in sequence. The first fixed support arm 31 is connected to the support base 1. The first movable support arm 33 is connected to the brake member 4. With this arrangement, when the second shape memory alloy wire 6 drives the brake elastic member 3 to elastically deform, the first movable support arm 33 moves towards the first fixed support arm 31, effectively driving the brake member 4 away from the swing arm 2, achieving rapid unlocking of the swing arm 2.

In this embodiment, the brake elastic member 3 is a bent spring leaf that is V-shaped or U-shaped. The first fixed support arm 31 and the first movable support arm 33 are plate-like, providing a more reliable connection and assembly with the support base 1 and the brake member 4. In other embodiments, the brake elastic member 3 may also be a conventional elastic member such as a helical spring.

In one or more embodiments, the brake member 4 is provided with a force-receiving part 41, and the second shape memory alloy wire 6 is configured to drive the force-receiving part 41 to move. This arrangement allows the second shape memory alloy wire 6 to safely and reliably apply a force to the brake member 4.

In one or more embodiments, the force-receiving part 41 has a protruding structure, and the second shape memory alloy wire 6 is wound around the force-receiving part 41. This arrangement ensures a more stable and reliable transmission of force between the second shape memory alloy wire 6 and the brake member 4.

In one or more embodiments, the protruding structure of the force-receiving part 41 is provided with a winding groove, and the second shape memory alloy wire 6 is inserted into the winding groove, preventing the second shape memory alloy wire 6 from coming out of the force-receiving part 41.

In this embodiment, the force-receiving part 41 is a cylindrical or square protrusion whose axis is perpendicular to the extension direction of the second shape memory alloy wire 6. Two wire clips that cooperate with the second shape memory alloy wire 6 are disposed on the support base 1. Two ends of the second shape memory alloy wire 6 are connected to the two wire clips one to one. After the second shape memory alloy wire 6 is wound around the force-receiving part 41, the two segments of the second shape memory alloy wire 6 are parallel to each other.

In other embodiments, the force-receiving part 41 may also be a through-hole channel disposed on the brake member 4, enhancing the safety of the assembly and ensuring that the second shape memory alloy wire 6 threaded through the force-receiving part 41 is less likely to disengage from the brake member 4.

In one or more embodiments, two first shape memory alloy wires 5 are provided, and the two first shape memory alloy wires 5 are configured to drive the swing arm 2 to swing in opposite directions. In this arrangement, the two first shape memory alloy wires 5 work together to drive the actuator part 22 of the swing arm 2 to generate strokes in positive and negative directions, better improving the brake stroke.

In one or more embodiments, each first shape memory alloy wire 5 is configured with one traction part 21, and the two traction parts 21 are parallel to each other and spaced apart.

In one or more embodiments, the first shape memory alloy wire 5 and the second shape memory alloy wire 6 are located on two sides of the brake member 4 along the thickness direction. This arrangement prevents the mutual interference between the first shape memory alloy wire 5 and the second shape memory alloy wire 6.

In this embodiment, when the two first shape memory alloy wires 5 are de-energized, the actuator part 22 is in an intermediate state. When one first shape memory alloy wire 5 is energized, this first shape memory alloy wire 5 can drive the actuator part 22 to swing in the positive direction by the set distance through the traction part 21 around which this first shape memory alloy wire 5 is wound. When the other first shape memory alloy wire 5 is energized, this first shape memory alloy wire 5 can drive the actuator part 22 to swing in the negative direction by the set distance through the traction part 21 around which this first shape memory alloy wire 5 is wound.

In one or more embodiments, the braking device also includes a swing arm elastic member 7, and the swing arm 2 is connected to the support base 1 by the swing arm elastic member 7. On the support base 1, the swing arm 2 is fully supported by the swing arm elastic member 7. The first shape memory alloy wire 5 is configured to drive the swing arm 2 to pull the swing arm elastic member 7 to elastically deform, causing the swing arm 2 to swing. This arrangement omits components and structures for rotational connection, such as shafts and bearings, and thus reduces the tolerance requirements. This allows the brake member to have a guaranteed locking effect, occupy an effectively reduced space compared with an existing rotary connection structure, and incur lower manufacturing costs.

In one or more embodiments, the swing arm elastic member 7 includes a second fixed support arm 71, a second intermediate part 72, and a second movable support arm 73 connected in sequence. The second fixed support arm 71 is connected to the support base 1. The second movable support arm 73 is connected to the swing arm 2. This arrangement makes the second movable support arm 73 approach the second fixed support arm 71 when the first shape memory alloy wire 5 drives the swing arm elastic member 7 to elastically deform, thus driving the swing arm 2 to swing efficiently.

In this embodiment, the brake elastic member 3 is a bent spring plate that is V-shaped or U-shaped; and the second fixed support arm 71 and the second movable support arm 73 are plate-like, providing a more reliable connection and assembly with the support base 1 and the swing arm 2. In other embodiments, the brake elastic member 3 may also be a common elastic member such as a helical spring.

In this embodiment, along the length direction of the bottom support plate 11, the traction part 21 and the actuator part 22 are located on one side of the swing arm elastic member 7, and the stopper part 23 is located on the other side of the swing arm elastic member 7. Along the length direction of the swing arm 2, the second movable support arm 73 of the swing arm elastic member 7 is connected between the stopper part 23 and the traction part 21. When both of the first shape memory alloy wires 5 are de-energized, under the driving of the swing arm elastic member 7, the actuator part 22 is stopped at the intermediate state.

The braking device of this embodiment can be applied to fields such as augmented reality (AR), virtual reality (VR), and cameras and can drive an optical module to change the focal point or drive a display module to be displaced.

### EMBODIMENT TWO

This embodiment provides a braking device. Components of this embodiment the same as or corresponding to those of embodiment one use the corresponding reference numerals or names in embodiment one. For simplicity, only differences between this embodiment and embodiment one are described hereinafter.

The difference between this embodiment and embodiment one is that the swing arm 2 is rotatably connected to the support base 1. This arrangement makes the swing arm 2 swing more stably and reliably and be displaced more precisely.

Compared with the structure in the related art where both a swing arm and a brake arm are rotatably connected, in this embodiment, the brake arm is replaced with the brake member 4 that is fully supported by the brake elastic member 3. This omits components and structures for rotational connection, such as shafts and bearings, making the brake member 4 have a more compact structure and a smaller occupied space.

In this embodiment, the support base 1 is provided with a shaft, the swing arm 2 is sleeved onto the shaft, and the shaft is located between the traction part 21 and the actuator part 22.

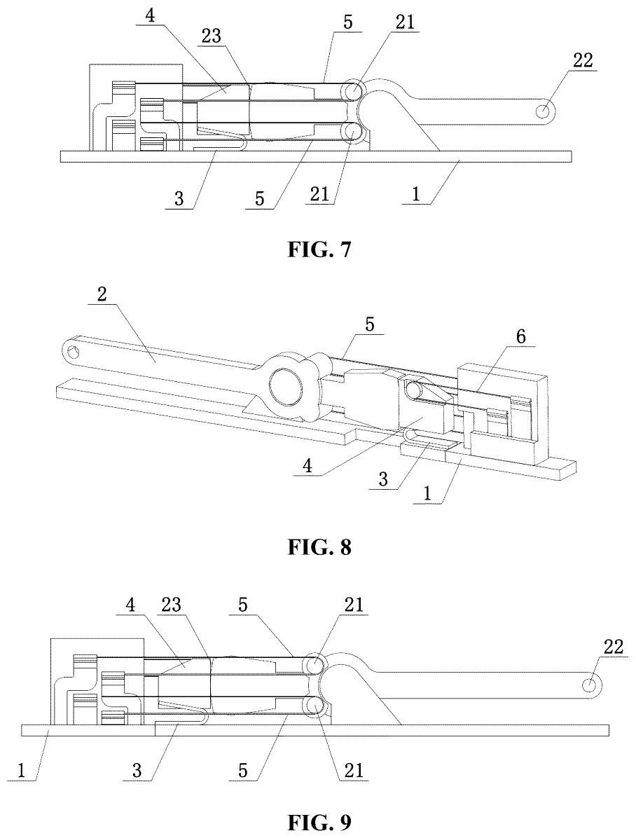

As shown in FIG. 6 and FIG. 7, if the space occupied by the swing arm in the related art is maintained, the overall space occupied by the braking device can be effectively reduced.

As shown in FIG. 8 and FIG. 9, if the overall space occupied by the braking device in the related art is maintained, the length of the swing arm 2 can be effectively extended, thereby improving the brake stroke.

### EMBODIMENT THREE

This embodiment provides a braking device. Components of this embodiment the same as or corresponding to those of embodiment one use the same or corresponding reference numerals of embodiment one. For convenience, only the differences between this embodiment and embodiment one are described below.

The difference between this embodiment and embodiment one is that there is one first shape memory alloy wire 5 in this embodiment. The first shape memory alloy wire 5 of this embodiment can drive the swing arm 2 to swing to the first limit position. The swing arm elastic member 7 of this embodiment can drive the swing arm 2 to swing to the second limit position. This arrangement better reduces the costs.

In this embodiment, when the first shape memory alloy wire 5 is de-energized, under the drive of the swing arm elastic member 7, the actuator part 22 swings in the positive direction by a set distance. When the first shape memory alloy wire 5 is energized, the traction part 21 around which the first shape memory alloy wire 5 is wound can drive the actuator part 22 to swing in the negative direction by a set distance.

### EMBODIMENT FOUR

This embodiment provides a braking device. Components of this embodiment the same as or corresponding to those of embodiment one use the same or corresponding reference numerals of embodiment one. For convenience, only the differences between this embodiment and embodiment one are described below.

The difference between this embodiment and embodiment one is as follows: Multiple first shape memory alloy wires 5 are provided. The multiple first shape memory alloy wires 5 are divided into several levels. When any two levels of the first shape memory alloy wires 5 have different deformation amounts when energized. This configuration allows the actuator part 22 to have multiple set brake strokes.

The first shape memory alloy wires 5 of different levels may have the same size specifications but different materials or may have the same material but different size specifications or may have different size specifications and different materials. This allows them to exhibit different deformation amounts when energized. The size specifications refer to the wire diameter and the wire length.

As shown in Table 1 below, using the first shape memory alloy wire 5 made of Ni—Ti and the first shape memory alloy wire 5 made of Ni—Ti—Cu as examples, the maximum pulling force and maximum deformation amount for these wires at different size specifications are illustrated as follows:

TABLE 1

| | | | | Maximum |
|---|---|---|---|---|
| | Wire | Wire | Maximum | Deformation |
| Alloy Wire | Diameter | Length | Pulling Force | Amount In |
| Material | (μm) | (mm) | (gf) | Length (mm) |
| Ni—Ti | 50 | 15 | 60 | 0.75 |
| | 50 | 20 | 60 | 1 |
| | 100 | 15 | 200 | 0.75 |
| | 100 | 20 | 200 | 1 |
| Ni—Ti—Cu | 50 | 15 | 80 | 0.75 |
| | 50 | 20 | 80 | 1 |
| | 100 | 15 | 280 | 0.75 |
| | 100 | 20 | 280 | 1 |

In this embodiment, among the multiple levels of first shape memory alloy wires 5, each level is provided with two first shape memory alloy wires 5. The two first shape memory alloy wires 5 at each level are able to drive the swing arm 2 to rotate in opposite directions. In this arrangement, the two first shape memory alloy wires 5 at each level work together to drive the actuator part 22 of the swing arm 2 to generate strokes in both positive and negative directions, thereby increasing the brake stroke corresponding to each level.

### EMBODIMENT FIVE

This embodiment provides a braking device. Components of this embodiment the same as or corresponding to those of embodiment one use the same or corresponding reference numerals of embodiment one. For convenience, only the differences between this embodiment and the previous embodiment are described below.

Based on any previous embodiment, the braking device of this embodiment also includes a sensor disposed on the support base 1 and configured to detect the position of the actuator part 22 of the swing arm 2.

In the braking device of this embodiment, the sensor can accurately detect and control the position of the actuator part 22 of the swing arm 2, allowing precise control of the brake stroke.

In one or more embodiments, the braking device also includes a controller that can control the operation of the first shape memory alloy wire 5 and the second shape memory alloy wire 6 according to the detection information from the sensor, causing the actuator part 22 of the swing arm 2 to move to a set position. The sensor is used to determine the current position of the actuator part 22 and feed back the position to the controller in real time, allowing the controller to quickly drive the actuator part 22 of the swing arm 2 to the set position.

In one or more embodiments, when the controller performs feedback control through the sensor, to prevent excessive vibration in the overall structure, a gel or damping structure is disposed on the braking device. This gel or damping structure interferes with the swing of the swing arm 2, making the movement of the actuator part 22 more stable and reliable.

In this embodiment, the gel or damping structure is disposed on the support base 1 and can interfere with the swing of the swing arm 2.

In a first implementation, the sensor is a current sensor, such as a Hall sensor or a tunnel magnetoresistance (TMR) sensor, which uses the magnetoelectric effect to detect distance. The sensor is disposed on the support base 1. A magnet that cooperates with the sensor is disposed on the swing arm 2. When the swing arm 2 swings, the swing arm 2 drives the magnet to move, and the current sensor detects the position of the magnet, thereby determining the real-time position of the actuator part 22 of the swing arm 2.

In a second implementation, the sensor is a current sensor, such as a Hall sensor or a TMR sensor, which uses the magnetoelectric effect to detect distance. The sensor is disposed on the support base 1. A slider is disposed on the support base 1. The sliding direction of the slider is perpendicular to the swing axis of the swing arm 2. The actuator part 22 of the swing arm 2 is connected to the slider by a spring. When the swing arm 2 swings to a certain position, the slider adapts to slide to the corresponding position. A magnet that cooperates with the current sensor is disposed on the slider. When the swing arm 2 swings, the swing arm 2 moves the magnet through the slider, and the current sensor detects the position of the magnet, thereby determining the real-time position of the actuator part 22 of the swing arm 2. In this implementation, the detection path of the sensor is converted from rotational to linear, and the flat cable design of the sensor allows for more flexible configuration of the position of the detection system such that the detection system can be placed closer to the power supply or signal input or in areas with more available space.

In a third implementation, the sensor is a photoelectric sensor disposed on the support base 1. A slider is disposed on the support base 1. The sliding direction of the slider is perpendicular to the swing axis of the swing arm 2. The actuator part 22 of the swing arm 2 is connected to the slider by a spring. When the swing arm 2 swings to a certain position, the slider adapts to slide to the corresponding position. The swing of the swing arm 2 drives the slider to move, and the photoelectric sensor detects the position of the slider, thus obtaining the real-time position of the actuator part 22 of the swing arm 2.

In a fourth implementation, the sensor is a pressure sensor. A positioning block is disposed on the support base 1. The pressure sensor is disposed on the positioning block. The actuator part 22 of the swing arm 2 is connected to the positioning block by a spring hook and abuts the pressure sensor. When the swing arm 2 swings to different positions, the spring applies different hook pressures to the pressure sensor. The pressure sensor detects the pressure value to determine the real-time position of the actuator part 22 of the swing arm 2.

In this embodiment, the controller outputs by controlling the operation of the first shape memory alloy wire 5 and the second shape memory alloy wire 6. The sensor detects the output result and feeds back the output result to the controller. The controller adjusts its control of the first shape memory alloy wire 5 and the second shape memory alloy wire 6 based on the feedback from the sensor, ultimately moving the actuator part 22 to the set position. The related structure and circuit control methods for the controller and the sensor are conventional in the field and are not elaborated here.

### EMBODIMENT SIX

This embodiment provides a braking method that uses the braking device of any previous embodiment. The method includes the following steps:

The second shape memory alloy wire 6 is energized to drive the brake member 4 away from the swing arm 2.

The first shape memory alloy wire 5 is energized to drive the traction part 21 to move to a set position.

The second shape memory alloy wire 6 is de-energized, and the brake elastic member 3 drives the brake member 4 to abut the swing arm 2.

The brake member 4 is connected to the support base 1 by the brake elastic member 3. On the support base 1, the brake member 4 is fully supported by the brake elastic member 3. The brake member 4 can be driven by the brake elastic member 3 to abut and lock the swing arm 2, allowing the swing arm 2 to achieve zero holding energy and efficiently maintain the brake stroke, ensuring the locking effect. The second shape memory alloy wire 6 can drive the brake member 4 to pull the brake elastic member 3 to elastically deform, causing the brake member 4 to move away from the swing arm 2. When moving away from the swing arm 2, the brake member 4 releases the locking of the swing arm 2. This arrangement omits components and structures for rotational connection, such as shafts and bearings, and thus reduces the tolerance requirements. This allows the brake member 4 to have a guaranteed locking effect, occupy an effectively reduced space compared with an existing brake arm, and incur lower manufacturing costs.

Based on the structure of the braking device of embodiment one, the actuation method of this embodiment includes the following steps:

In step one, the second shape memory alloy wire 6 is energized to drive the brake member 4 away from the stopper part 23.

In this step, when the current is applied to the second shape memory alloy wire 6, the temperature of the second shape memory alloy wire 6 rises, and the length of the second shape memory alloy wire 6 becomes shorter so that the force-receiving part 41 is pulled and the brake elastic member 3 is compressed, thus releasing the brake on the swing arm 2 and ultimately placing the swing arm 2 in a free state.

In step two, the first shape memory alloy wire 5 is energized to drive the traction part 21 to move and drive the actuator part 22 to the set position.

In this step, as required, when the current is applied to one first shape memory alloy wire 5, the temperature of this first shape memory alloy wire 5 rises and the length of the first shape memory alloy wire 5 becomes shorter so that the corresponding traction part 21 is pulled, causing the swing arm 2 to swing until the actuator part 22 on the swing arm 2 reaches the set position.

In step three, the second shape memory alloy wire 6 is de-energized, and the brake elastic member 3 drives the brake member 4 to abut the stopper part 23.

In this step, the second shape memory alloy wire 6 is de-energized, the length of the second shape memory alloy wire 6 recovers, and the brake elastic member 3 drives the brake member 4 to rotate until the brake member 4 abuts the stopper part 23 of the swing arm 2 and locks the swing arm 2 in a braked state.

In the fourth step, the first shape memory alloy wire 5 is de-energized, and the brake member 4 maintains the brake stroke under the drive of the brake elastic member 3.

Apparently, the preceding embodiments of the present disclosure are illustrative of the present disclosure and are not intended to limit embodiments of the present disclosure. Those of ordinary skill in the art can make changes or variations in other different forms based on the preceding description. It is neither necessary nor possible to enumerate all the embodiments here. Any modifications, equivalent substitutions, and improvements made within the principle of the present disclosure fall within the scope of the claims of the present disclosure.

What is claimed is:

1. A braking device, comprising:
a support base;
a swing arm mounted on the support base and configured to swing relative to the support base;
a brake elastic member connected to the support base;
a brake member, wherein the brake member is connected to the support base by the brake elastic member, and the brake elastic member is configured to drive the brake member to abut and lock the swing arm;
a first shape memory alloy wire disposed on the support base and configured to drive the swing arm to swing when energized; and
a second shape memory alloy wire disposed on the support base and configured to drive the brake member away from the swing arm to release the swing arm when energized.

2. The braking device of claim 1, wherein the brake elastic member comprises a first fixed support arm, a first intermediate part, and a first movable support arm connected in sequence, wherein the first fixed support arm is connected to the support base, and the first movable support arm is connected to the brake member.

3. The braking device of claim 1, further comprising a swing arm elastic member, wherein the swing arm is connected to the support base through the swing arm elastic member.

4. The braking device of claim 3, wherein the swing arm elastic member comprises a second fixed support arm, a second intermediate part, and a second movable support arm connected in sequence, wherein the second fixed support arm is connected to the support base, and the second movable support arm is connected to the swing arm.

5. The braking device of claim 1, wherein the swing arm is rotatably connected to the support base.

6. The braking device of claim 1, wherein two first shape memory alloy wires are provided, and the two first shape memory alloy wires are configured to drive the swing arm to swing in opposite directions.

7. The braking device of claim 1, wherein the swing arm is provided with a traction part, an actuator part, and a stopper part, the first shape memory alloy wire is configured to drive the traction part to move, and the brake member is configured to abut the stopper part.

8. The braking device of claim 7, wherein the stopper part has a curved surface, and the brake member is configured to abut different positions of the curved surface when the actuator part moves to different positions.

9. The braking device of claim 1, wherein the brake member is provided with a force-receiving part, and the second shape memory alloy wire is configured to drive the force-receiving part to move.

10. The braking device of claim 1, further comprising a sensor disposed on the support base and configured to detect a position of an actuator part of the swing arm.

11. The braking device of claim 2, further comprising a sensor disposed on the support base and configured to detect a position of an actuator part of the swing arm.

12. The braking device of claim 3, further comprising a sensor disposed on the support base and configured to detect a position of an actuator part of the swing arm.

13. The braking device of claim 4, further comprising a sensor disposed on the support base and configured to detect a position of an actuator part of the swing arm.

14. The braking device of claim 5, further comprising a sensor disposed on the support base and configured to detect a position of an actuator part of the swing arm.

15. The braking device of claim 6, further comprising a sensor disposed on the support base and configured to detect a position of an actuator part of the swing arm.

16. The braking device of claim 7, further comprising a sensor disposed on the support base and configured to detect a position of the actuator part of the swing arm.

17. The braking device of claim 8, further comprising a sensor disposed on the support base and configured to detect a position of the actuator part of the swing arm.

18. The braking device of claim 9, further comprising a sensor disposed on the support base and configured to detect a position of the actuator part of the swing arm.
